(19) United States
(12) Patent Application Publication
(10) Pub. No.: US 2015/0165906 A1
(43) Pub. Date: Jun. 18, 2015

(54) DISPLAY APPARATUS AND METHOD FOR VEHICLE

(71) Applicant: Hyundai Motor Company, Seoul (KR)

(72) Inventor: Jong Bok Lee, Yongin (KR)

(73) Assignee: HYUNDAI MOTOR COMPANY, Seoul (KR)

(21) Appl. No.: 14/264,509

(22) Filed: Apr. 29, 2014

(30) Foreign Application Priority Data
Dec. 18, 2013 (KR) 10-2013-0158460

(51) Int. Cl. B60K 35/00; G02B 27/01

(52) U.S. Cl. CPC B60K 35/00; G02B 27/01

(57) ABSTRACT

A display apparatus and method for a vehicle is provided. The display apparatus includes a display panel disposed within a dashboard and operated by a controller to display a first image that corresponds to a first polarization component and a second image that corresponds to a second polarization component. The controller is configured to determine that the first image is displayed on a first screen and the second image is displayed on a windshield glass. A first polarizing film is attached to one surface of the first screen through which the controller is configured to transmit the first image that corresponds to the first polarization component. Further, a second polarizing film is attached to one surface of a second screen, which is disposed on an upper surface of the dashboard, through which the controller is configured to transmit the second image that corresponds to the second polarization component.

### CROSS-REFERENCE TO RELATED APPLICATION

This application claims priority to and the benefit of Korean Patent Application No. 10-2013-0158460 filed in the Korean Intellectual Property Office on Dec. 18, 2013, the entire contents of which are incorporated herein by reference.

### BACKGROUND

(a) Field of the Invention

The present invention relates to a display apparatus and method for a vehicle and more particularly, to a display apparatus and method that display two different images using one display panel.

(b) Description of the Related Art

In general, a heads-up display (HUD) apparatus has been developed to provide flight information to an airplane pilot, and is mounted within an aircraft. Recently, the HUD apparatus has been applied to a vehicle to conveniently indicate driving information of the vehicle to a driver. The HUD apparatus applied to the vehicle projects a display image that includes driving information onto a windshield glass. The virtual image that corresponds to the display image projected onto the windshield glass is visually recognized by the driver. Accordingly, the driver recognizes driving information while maintaining a forward gaze, and thus improving convenience and safety of the driver.

Further, a cluster apparatus provides vehicle speed information, engine speed information, coolant temperature information, fuel level information, and operating state information of various devices to the driver using various lamps and pointers. Research for displaying this cluster information as an image is being actively conducted. In addition, to respectively display driving information on the windshield glass and the cluster apparatus, two display devices are required. However, when the two display devices are installed within the vehicle, production cost, power consumption, and installation space increase.

The above information disclosed in this section is merely for enhancement of understanding of the background of the invention and therefore it may contain information that does not form the prior art that is already known in this country to a person of ordinary skill in the art.

### SUMMARY

The present invention provides a display apparatus and method for a vehicle that may display two different images using one display panel.

A display apparatus for a vehicle according to an exemplary embodiment of the present invention may include: a display panel disposed within a dashboard and configured to display a first image that corresponds to a first polarization component and a second image that corresponds to a second polarization component; a controller configured to determine the first image displayed on a first screen and the second image displayed on a windshield glass, and operate the display panel; a first polarizing film attached to one surface of the first screen and configured to transmit the first image that corresponds to the first polarization component; and a second polarizing film attached to one surface of a second screen, disposed on an upper surface of the dashboard, and configured to transmit the second image that corresponds to the second polarization component.

The controller may be configured to operate the display panel to simultaneously display the first image and the second image. The first image may include at least one of vehicle speed information, engine speed information, coolant temperature information, and fuel level information. The second image may include at least one of vehicle speed information and route guidance information. The display apparatus for the vehicle may further include a mode switch configured to select a display state of the second image. Therefore, accordingly to an exemplary embodiment of the present invention, two different images may be simultaneously displayed using one display panel. By using one display panel, production cost, power consumption, and installation space within the dashboard may be reduced.

### BRIEF DESCRIPTION OF THE DRAWINGS

FIG. 1 is an exemplary diagram of a display apparatus for a vehicle according to an exemplary embodiment of the present invention; and

FIG. 2 is an exemplary view showing an image displayed on a first screen and an image displayed on a windshield glass according to an exemplary embodiment of the present invention.

### DESCRIPTION OF SYMBOLS

5: Driving information collector
10: Display panel
20: Controller
32: First polarizing film
34: Second polarizing film
40: Mode switch
52: First screen
54: Second screen
60: Dashboard
70: Windshield glass

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. Further, since each component shown in the drawings is arbitrarily illustrated for easy description, the present invention is not particularly limited to the components illustrated in the drawings.

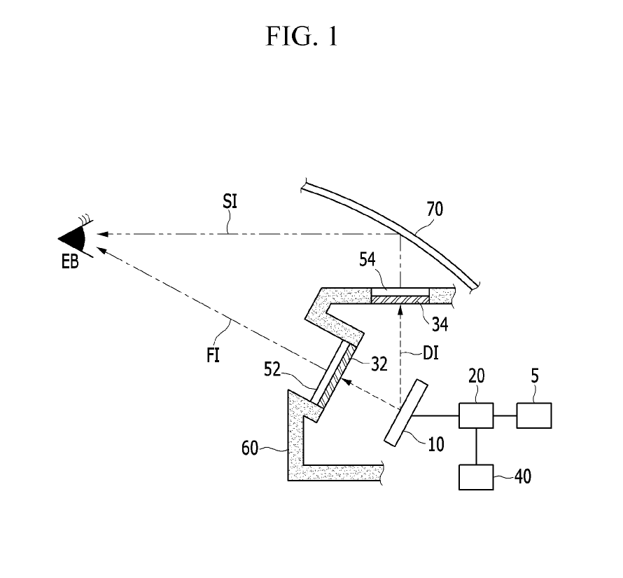

FIG. 1 is an exemplary diagram of a display apparatus for a vehicle according to an exemplary embodiment of the present invention. As shown in FIG. 1, a display apparatus for a vehicle according to an exemplary embodiment of the present invention may include a display panel 10, a controller 20, a first polarizing film 32, and a second polarizing film 34. The display panel 10 may be various display devices such as a liquid crystal display device (LCD), an organic light emitting display device (OLED), and a plasma display panel (PDP).

The display panel 10, which may be disposed within a dashboard 60, may be configured to receive an image signal from the controller 20 and display an image. The controller 20 may be connected to the display panel 10 and may be implemented with one or more microprocessors executed by a predetermined program. The predetermined program may include a series of commands for performing each step included in a method for operating the display panel 10 to display images according to an exemplary embodiment of the present invention.

Further, the controller 20 may be configured to receive driving information from a driving information collector 5 (e.g., a sensor) to determine an image to be displayed on the display panel 10. The driving information collector 5 may be configured to collect driving information from various sensors, electronic control units, and devices via an internal network of the vehicle. The driving information may include vehicle speed information, engine speed information, coolant temperature information, fuel level information, vehicle position information, route guidance information, and operating state information of various devices.

The controller 20 may be configured to determine a first image FI displayed on a first screen 52 based on the driving information. The first image FI may include vehicle speed information, engine speed information, coolant temperature information, fuel level information, accumulated distance information, traveled distance information, operating state information of lamps (e.g., turn signal lamps or high beam lamps), operating state information of devices (e. g., doors, seat belts, or a battery), and the like. In other words, the first image FI may be an image that corresponds to information provided from a known cluster apparatus. Additionally, the controller 20 may be configured to determine a second image SI displayed on a windshield glass 70 based on the driving information. The second image SI may include vehicle speed information, route guidance information, and the like. In other words, the second image SI may be an image that corresponds to information provided from a known heads-up display apparatus.

The controller 20 may be configured to operate the display panel 10 to display the first image FI that corresponds to a first polarization component. Further, the controller 20 may be configured to operate the display panel 10 to display the second image SI that corresponds to a second polarization component. The first polarization component may be a P wave polarization component and the second polarization component may be an S wave polarization component. In addition, the first polarization component may be an S wave polarization component and the second polarization component may be a P wave polarization component.

The controller 20 may be configured to operate the display panel 10 to simultaneously display the first image FI and the second image SI. In other words, the display panel 10 may be configured to display an image DI that includes the first image FI corresponding to the first polarization component and the second image SI corresponding to the second polarization component. The image DI, which may be displayed by the display panel 10, is indicated by dotted lines in FIG. 1. The first image FI is indicated by one-point chain lines, and the second image SI is indicated by two-point chain lines.

The first polarizing film 32 may be attached to one surface (e.g., a first surface) of the first screen 52 to transmit the first image FI that corresponds to the first polarizing component. The first image FI may be visually recognized by a viewer such as a driver through a predetermined eye box EB. The second polarizing film 34 may be attached to one surface (a first surface) of a second screen 54, which may be disposed on an upper surface of the dashboard 60, to transmit the second image SI that corresponds to the second polarizing component. The transmitted second image SI may be directly displayed on the windshield glass 70. The virtual image of the second image SI may be visually recognized by the driver through the predetermined eye box EB.

The display apparatus for the vehicle according to an exemplary embodiment of the present invention may further include a mode switch 40 executed by the controller to select a display state of the second image SI. The controller 20 may be configured to determine whether to display the second image SI, and may be configured to operate the display panel 10. The second image SI may be displayed when the mode switch 40 is turned on and the second image SI may not be displayed when the mode switch 40 is turned off. In other words, only the first image FI may be displayed using the mode switch 40 (e.g., by controller the mode switch 40 to be either on or off).

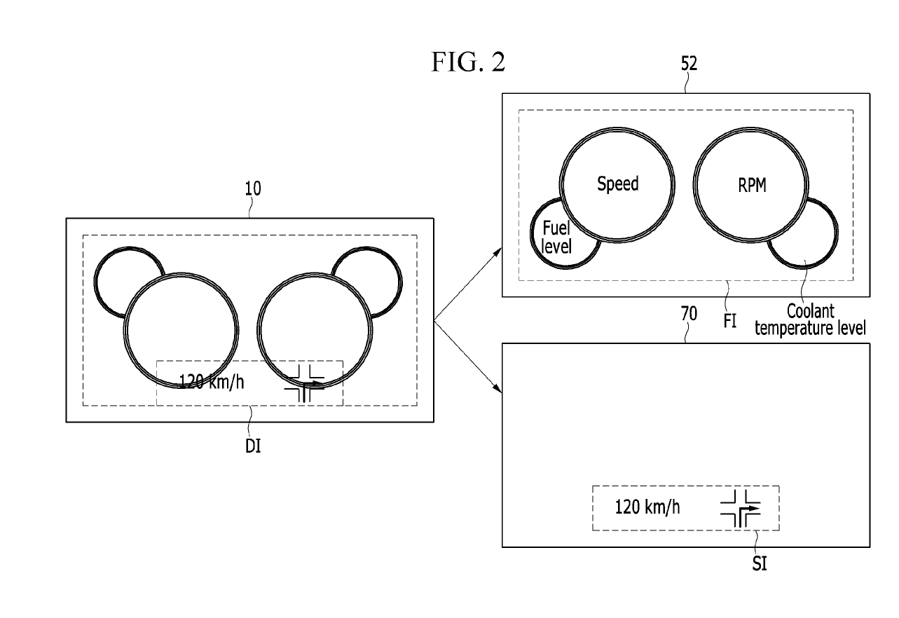

FIG. 2 is an exemplary drawing showing an image displayed on a first screen and an image displayed on a windshield glass according to an exemplary embodiment of the present invention. As shown in FIG. 2, the display panel 10 may be configured to display the image DI that includes the first image FI corresponding to the first polarization component and the second image SI corresponding to the second polarization component.

The first image FI displayed on the first screen 52 may include vehicle speed information, engine speed information, coolant temperature information, fuel level information, and the like. The second image SI displayed on the windshield glass 70 may include vehicle speed information, route guidance information, and the like. As described above, according to an exemplary embodiment of the present invention, two different images FI and SI may be simultaneously displayed using the display panel 10. In particular, by using one display panel 10, production cost, power consumption, and installation space within the dashboard 60 may be reduced.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

What is claimed is:

1. A display apparatus for a vehicle, comprising:
a display panel disposed within a dashboard;
a controller configured to:
operate the display panel to display a first image that corresponds to a first polarization component and a second image that corresponds to a second polarization component; and
determine that the first image is displayed on a first screen and the second image is displayed on a windshield glass;
a first polarizing film attached to one surface of the first screen through which the controller is configured to transmit the first image that corresponds to the first polarization component; and
a second polarizing film attached to one surface of a second screen, which is disposed on an upper surface of the dashboard and through which the controller is configured to transmit the second image that corresponds to the second polarization component.

2. The display apparatus for the vehicle of claim 1, wherein the controller is configured to operate the display panel to simultaneously display the first image and the second image.

3. The display apparatus for the vehicle of claim 1, wherein the first image includes at least one selected from a group consisting of: vehicle speed information, engine speed information, coolant temperature information, and fuel level information.

4. The display apparatus for the vehicle of claim 1, wherein the second image includes at least one selected from a group consisting of: vehicle speed information and route guidance information.

5. The display apparatus for the vehicle of claim 1, wherein the controller is further configured to:
display the second image when a mode switch is turned on.

6. A method of displaying images using a display apparatus for a vehicle, comprising:
operating, by a controller, a display panel to display a first image that corresponds to a first polarization component and a second image that corresponds to a second polarization component;
determining, by the controller, that the first image is displayed on a first screen and the second image is displayed on a windshield glass;
transmitting, by the controller, the first image that corresponds to the first polarization component through a first polarizing film attached to one surface of the first screen; and
transmitting, by the controller, the second image that corresponds to the second polarization component through a second polarizing film attached to one surface of a second screen which is disposed on an upper surface of the dashboard.

7. The method of claim 6, further comprising:
operating, by the controller, the display panel to simultaneously display the first image and the second image.

8. The method of claim 6, wherein the first image includes at least one selected from a group consisting of: vehicle speed information, engine speed information, coolant temperature information, and fuel level information.

9. The method of claim 6, wherein the second image includes at least one selected from a group consisting of: vehicle speed information and route guidance information.

10. The method of claim 6, further comprising:
displaying, by the controller, the second image when a mode switch is turned on.

11. A non-transitory computer readable medium containing program instructions executed by a controller, the computer readable medium comprising:
program instructions that control a display panel to display a first image that corresponds to a first polarization component and a second image that corresponds to a second polarization component;
program instructions that determine that the first image is displayed on a first screen and the second image is displayed on a windshield glass;
program instructions that transmit the first image that corresponds to the first polarization component through a first polarizing film attached to one surface of the first screen; and
program instructions that transmit the second image that corresponds to the second polarization component through a second polarizing film attached to one surface of a second screen which is disposed on an upper surface of the dashboard.

12. The non-transitory computer readable medium of claim 11, further comprising:
program instructions that control the display panel to simultaneously display the first image and the second image.

13. The non-transitory computer readable medium of claim 11, wherein the first image includes at least one selected from a group consisting of: vehicle speed information, engine speed information, coolant temperature information, and fuel level information.

14. The non-transitory computer readable medium of claim 11, wherein the second image includes at least one selected from a group consisting of: vehicle speed information and route guidance information.

15. The non-transitory computer readable medium of claim 11, further comprising:
program instructions that display the second image when a mode switch is turned on.
